(19) United States
(12) Patent Application Publication
(10) Pub. No.: US 2010/0178015 A1
(43) Pub. Date: Jul. 15, 2010

(54) CABLE DUCT AND BRANCH

(75) Inventors: Helmut Kadrnoska, Vienna (AT); Gerhard Reiss, Laxenburg (AT)

Correspondence Address: LERNER GREENBERG STEMER LLP, P O BOX 2480, HOLLYWOOD, FL, 33022-2480, US

(73) Assignee: CABLERUNNER AUSTRIA GMBH & CO. KG, Vienna (AT)

(21) Appl. No.: 12/666,907

(22) PCT Filed: Jun. 25, 2008
(86) PCT No.: PCT/AT2008/000230

§ 371 Date: Jan. 26, 2010

(30) Foreign Application Priority Data
Jun. 25, 2007 (AT) A 987/2007

(51) Int. Cl. G02B 6/44

(52) U.S. Cl. 385/100

(57) ABSTRACT

A cable duct for guiding a plurality of cables is produced from an elastic material. The cable duct has an upper profiled part and a lower profiled part. The lateral end sections of the opposite profiled parts, in the position of use of the cable duct, terminate the cable duct as closing parts. The lateral end sections rest one on the other or are forced one against the other. The profiled parts are held together by retaining elements that can be immobilized by joining. Retaining elements are at the same distance to a center of a cross-section of the cable duct and at the same distance to the lateral end sections. Chambers for guiding lines or cables are delimited at both sides of the center and/or in the sections of the profiled parts that are laterally contiguous to the closing parts by the retaining elements.

The invention relates to a cable duct according to the precharacterising part of claim 1 and to a diverter for a cable duct.

WO 2005/045296 A1 discloses a flexible duct for air-conditioning lines, in particular gas or liquid lines, but also electric lines. The duct is of one- or two-part construction; in the two-part construction, both parts are identical. The two parts are connected to one another by a latching/snap connection. The inside of the parts has formed-on features for various pipes or conductors. In a further configuration, the duct is of one-piece design. It has at its two longitudinal edges a snap or clamping closure, which is additionally secured by means of a clamp.

U.S. Pat. No. 6,274,813 B discloses a flexible cable duct of one-part design, which may also be used in two parts owing to the asymmetrical configuration of the clamping and snap edges. The edges can be connected to one another by a clamp, the clamp being additionally designed as a mounting aid. In a further configuration, the cable duct has dividing walls.

U.S. Pat. No. 3,455,336 A discloses a flexible duct for pipes or cables. The duct is of one- or two-part design and has two clamping edges with a bead. The two edges are held by means of one or two clamping rails. The edges may have a configuration with diametrically opposed profiles.

The background of the invention is the laying of lines, in particular optical waveguides, in pipe systems, in particular sewage pipe systems. In contrast to trenches, the digging of which involves extensive work especially in urban areas, pipe systems which already exist may be used for the guiding of lines. There are significant advantages with laying in sewage systems in that, owing to the depth at which the conduits are located, there is virtually no risk of damage due to other excavations. Furthermore, conduits in urban areas are subject to an annual inspection. The typical damage caused mechanically by sewage or by possible rodent biting can be controlled by methods according to the prior art. For point-to-point connections, such laying methods are perfectly adequate, since in this case the line is merely guided within the network and no branching-off is carried out.

In the construction of data networks, however, it is necessary to lay cable ducts in the pipe system or in the conduits and to form branching-off points. The object according to the invention is to provide an efficient, structurally simple and economical possibility for the production and laying of cable ducts and the laying and branching-off of lines, in particular for constructing data networks, the cables being laid in cable ducts in pipe networks, in particular in sewage networks.

The invention achieves this object in the case of a cable duct of the type mentioned at the outset by the features given in the characterising part of claim 1.

A significant advantage of the invention consists in the structurally simple construction of the cable duct, which is easy to lay and guides the lines safely, it being possible within a sewage pipe system to branch off individual cables from a cable duct without great expenditure for the construction of networks.

It is of particular advantage that the cable duct is produced from elastic plastic, since flexibility is essential both in the longitudinal direction and in the transverse direction for simple introduction of the cable duct into a corresponding piping system and adaptation thereto and for joining the profile parts together.

For the production and laying, it is advantageous that the cable duct is of two-part construction and is composed of profile parts which are latchable to one another, since the formation of integrated chambers for the cables is thereby simplified. If the two profile parts are of identical shape, the expenditure in the production is reduced to one element.

The features of the characterising part of claim 2 result in the cable duct better adapting to pipes used to receive the cable duct and thus less space being required in the sewage pipe for the cable duct.

A design of the cable duct according to claim 4 has the advantage that the closing parts, which cover the cables situated laterally in the cable duct, are held or pressed together by the elastic bracing of the cable duct and thus it is possible to prevent the cables from escaping from the cable duct.

According to claim 5, it is advantageous to provide dividing walls which prevent a screw used in the fastening of the cable duct to the inner wall of a pipe from being able to damage the individual cables lying in the chambers bounded by the dividing walls.

For a simple separation of the individual cables, it is expedient for the dividing walls, which are arranged on the individual profile parts, to be mutually opposite in the assembled state of the profile parts. A simple dividing-off of chambers and at the same time a stiffening of the cable duct can be achieved by providing cooperating stops on the mutually opposite dividing walls of the two profile parts. By increasing the number of dividing walls, the number of chambers in the cable duct can be increased.

For the branching-off of cables, the features of claim 9 are advantageous. For mounting, the diverter can be pushed onto the cable duct in the longitudinal direction. For simple and secure attachment of a diverter to the cable duct, the features of claims 8 and/or 9 are expedient. It has proved advantageous for a holding projection to be provided on the closing parts, since this makes it difficult or impossible for the diverter during operation to be inadvertently detached from the cable duct.

As a result of the curved shape of the profiled recesses of the closing parts, it is possible for the diverter to be pivotably mounted on the cable duct, affording the advantage that the diverter can be positionally adapted to the curvature of the pipe to which the cable duct is to be fastened. Furthermore, it is expedient for the diverter to be displaceable in a smooth-running manner in the longitudinal direction of the cable duct, since the diverter can thus be easily brought to a desired position.

The features of claim 11 result in a cable being able to be introduced into the cable duct or led out of the cable duct simply and without appreciable friction. Furthermore, the region of the cable duct which is opened by the splaying part can be kept small.

An embodiment of a diverter according to claim 13 has the advantage that the splaying of the cable duct in a desired region is as large as possible, while undesired gaps and openings to the side of the diverter are reduced as far as possible.

Furthermore, it is advantageous to provide a leadthrough for cables in the diverter body, thus preventing the interior of the cable duct and inner parts of the diverter from being soiled by sewage. Preferably, only one cable is branched off by a diverter.

The invention is explained in more detail below, by way of example, with reference to the drawing.

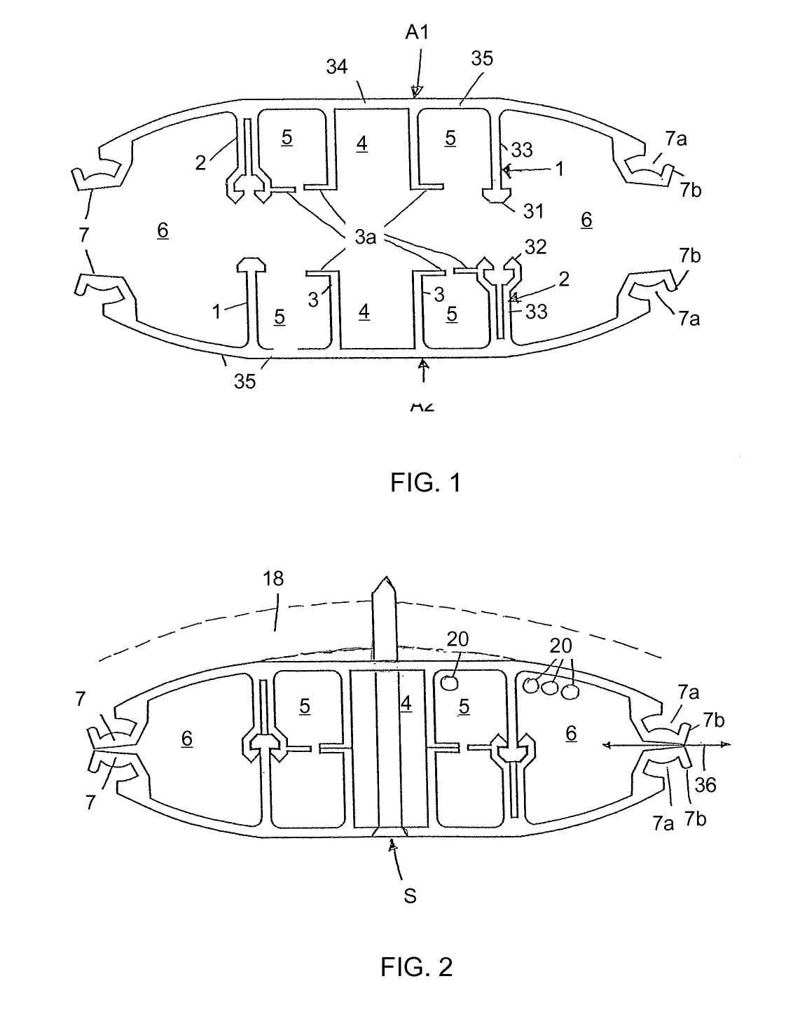

FIG. 1 shows a cable duct comprising two profile parts or half-shells, the two half-shells being identical.

FIG. 2 shows the cable duct according to FIG. 1, the cable duct having been brought into its final position with joined-together profile parts on a pipe inner wall.

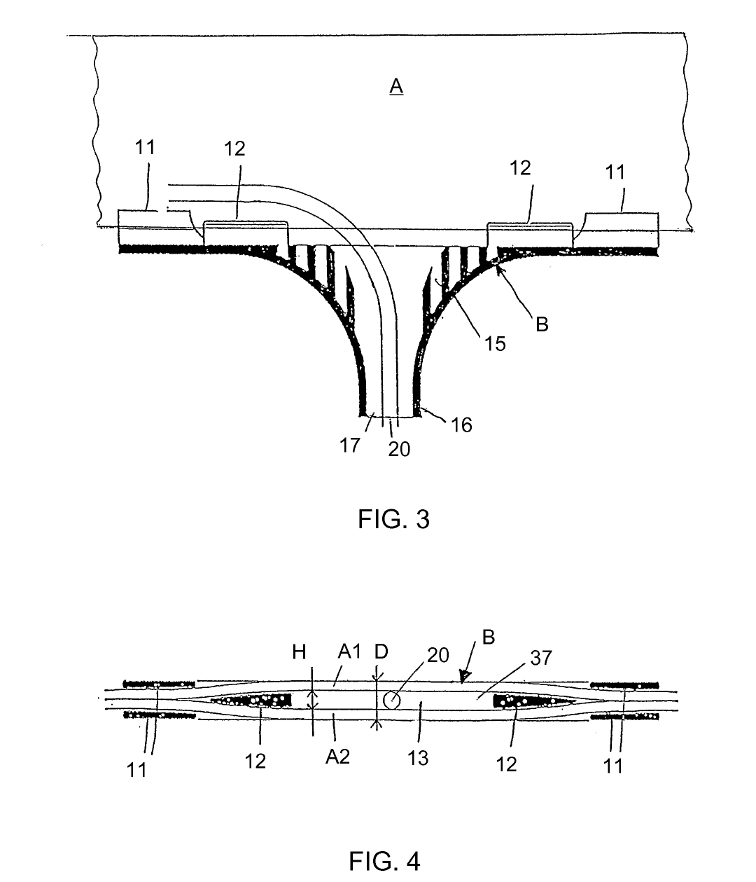

FIG. 3 shows, schematically, a diverter for a cable duct in plan view.

FIG. 4 shows the diverter in section in its connecting region.

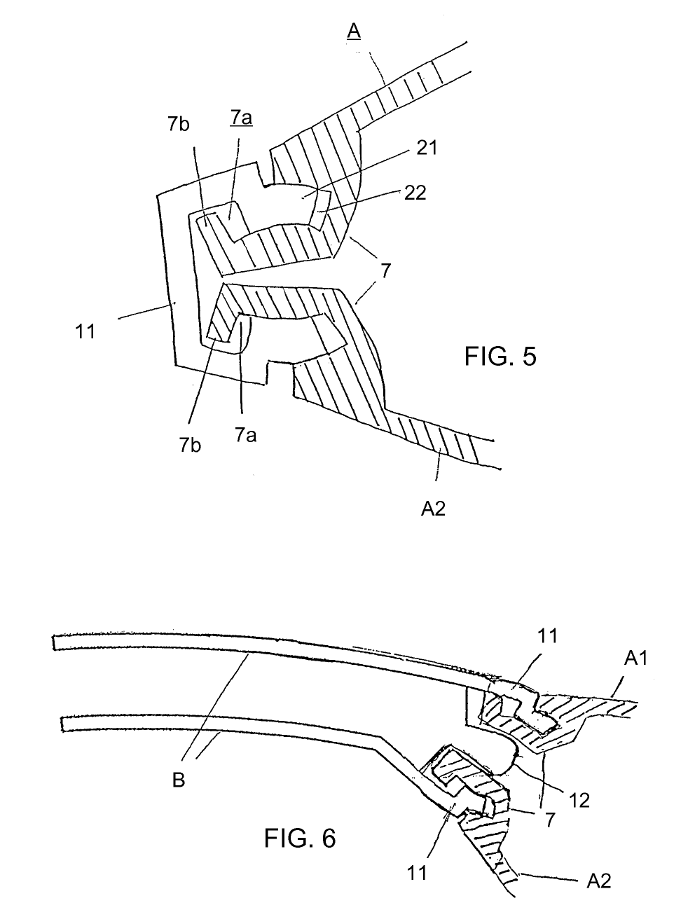

FIG. 5 shows a section, in the region of the lateral end regions of the profile parts, through a guide part.

FIG. 6 shows a section through a diverter connected to a cable duct.

FIGS. 1 and 2 show a cable duct A, which is produced from two profile parts or half-shells A1, A2, in the unconnected and in the assembled state of the profile parts, respectively. Both parts of the cable duct A, namely the upper profile part A1 and the lower profile part A2, are formed by identical profiles. Latchable holding elements 1, 2 are essential for holding together the two profile parts A1 and A2 of the cable duct A, these holding elements being mutually opposite or formed mutually oppositely on the half-shells in the cable duct A. The holding elements 1, 2 are arranged on the profile parts A1, A2 in such a way that they can engage with one another. Owing to the fact that the cable duct A is produced from identical parts, it follows that the holding elements 1, 2 are equidistant from the cross-sectional centre of the cable duct A. In this specific embodiment, the holding elements are formed by latching lugs 31 and latching grooves 32 latchable thereto, these holding elements each lying in the end region of webs 33. Other design variants, such as, for example, latchable hooks, may also be provided. Dividing walls 3 leading off from the wall 35 of the profile parts A1, A2 may be provided between the holding elements 1, 2. Stops 3a may be provided may be provided at the ends of the dividing walls 3 and also on the latching grooves 32 and the webs 33. These stops serve primarily for forming stable chambers 5, from which the cables 20 cannot escape.

The central region 4 divided off by the dividing walls 3 is advantageously kept free from cables. This central region 4 is provided for fitting a holding screw S, which is intended to secure the cable duct A to the pipe 19 surrounding the latter. Plugs are normally used for the attachment of the screw S to the pipe 19, in order to strengthen the holding force of the screw in the pipe or in the masonry behind the latter.

A plurality of inner chambers 5, which are bounded by dividing walls 3 and stops 3a, may be formed in the region between the latching lug 1 and the latching groove 2 of a profile part A1, A2.

Furthermore, there is the possibility of guiding cables 20 in outer chambers 6, which lie between the holding elements 1, 2 and the lateral end regions of the profile parts A1 and A2. Cables situated in outer chambers 6 can be introduced into or led out of the cable duct A between these two end regions or closing parts 7 of the upper profile part A1 and of the lower profile part A2, as indicated by arrow 36.

The outer surface of the profile parts A1, A2 is convexly curved at least over partial regions, the lateral end regions of the profile parts A1, A2 serving or being formed as closing parts 7 bearing against one another. Such a curvature of the wall surfaces of the cable duct A enables good adaptation of the cable duct A to, or bearing of it against, the pipe inner wall.

The production of the two profile parts A1 and A2 from elastic plastic and the elastic deformability thereby provided is particularly advantageous for the splaying of the end regions 7 bearing against one another in order to lead cables through and for adaptation to different pipe diameters or cross-sections, since as great an area of the upper profile part A1 as possible can thereby bear against the pipe.

Owing to the latching of the two profile parts A1, A2 by means of the latching lugs 31 and latching grooves 32, pressure is exerted on the lateral end regions or closing parts 7 through an appropriate choice of the length of the webs 33 and of the shell shape of the two profile parts A1, A2, and these end regions or closing parts 7 are pressed against one another and held in a position bearing against one another.

The closing parts 7 each have on the outside a profiled recess 7a, which is adapted to the shape of guide parts 11 of a diverter B. In addition, the closing parts 7 each have a holding projection 7b, which is situated at the outermost edge of the closing part 7 and bounds the profiled recess 7a.

For the purpose of introducing a cable 20 into or leading it out of the cable duct A, a diverter B, illustrated by way of example in FIGS. 3 and 4, is used. This diverter B comprises a diverter body 15, which, on its side facing the cable duct A, has two guide parts 11, two splaying parts 12 and an aperture 13 for leading cables 20 through. On the side of the diverter body 15 remote from the cable duct A, a cable leadthrough 17 is formed in the diverter body 15. In the embodiment illustrated, one guide part 11, one splaying part 12 and the aperture 13 for guiding the cable are arranged in the diverter body 15 next to one another in the longitudinal direction of the cable duct A or in the direction of the course of the area 18 in which the aperture 13 is formed. Furthermore, a further splaying part 12 and a further guide part 11 are arranged on the other side of the aperture 13, with the result that the diverter according to FIGS. 3 and 4 is symmetrical in relation to a plane which is normal to the longitudinal extent of the cable duct A. The splaying parts 12 are wedge-shaped extensions leading off from the diverter body B. It is of advantage furthermore for the profiled recesses 7a to lie, when the profile parts A1, A2 are latched together, symmetrically with respect to a central plane running between the upper profile A1 and the lower profile part A2. A special connecting geometry for the diverter B is thus not necessary.

The guide part 11 and the further guide part 11 each have the task of keeping the diverter B in position, or keeping the closing parts 7 of the profile parts A1 and A2 of the cable duct A in a position pressed against one another or pressed together, as soon as the splaying parts 12 have been introduced into the cable duct A in order to keep the latter open over a distance corresponding approximately to the length of the aperture 13. The height H of the splaying 37, caused by the splaying parts 12, of the lateral end regions of the cable duct A corresponds at least to the diameter of the cable 20 to be introduced into the cable duct A, the curvature of the course of the bending-open of the profile parts A1, A2 being determined by their maximum bending loading. The length of the splaying or opening 37 is determined by the mutual spacing of the two splaying parts 12. If the splaying lengths are too great, it has to be borne in mind that, in the central region between the two splaying parts 12, the two closing parts 7 of the cable duct A may approach one another owing to the elastic properties of the profile parts A1, A2.

The length of the splaying and of the aperture 13 of the diverter B are also to be dimensioned such that appropriate minimum bending radii for the cables 20 are observed, so as not to damage the latter during laying.

According to FIG. 4, which shows the side view of the diverter B, the splaying parts 12 predetermine the height H of the splaying 37. In the longitudinal direction of the cable duct A, the splaying parts 12 have, with increasing distance from the aperture 13, a continuously decreasing height, so that the splaying 37 decreases accordingly.

An advantageous property of diverter B and cable duct A is that the diverter B, in the introduced position, can be pivoted with respect to the cable duct A. The displaceability of the diverter in the longitudinal direction enables an exact positioning of branching-off pipes; the pivotability enables different pipe curvatures to be taken into account. The same diverter B may thus be used for many different pipe radii. For this purpose, the guide part 11 has, according to FIG. 5, in its end region a mating profile with respect to the profiled recess 7a. The shape of the mating profile is adapted to the shape and surface of the profiled recess 7a. An end part 21 of the mating profile is received by an end groove 22 of the profiled recess 7a or is adjustably mounted in this end groove 22. The profiles of surfaces of the profiled recess 7a and of the mating profile which bear against one another may have the same curvature, thus enabling the guide part 11 to pivot with respect to the closing parts 7. Situated at the outermost end of the closing part 7 is a holding projection 7b, which prevents the mating profile of the guide part 11 from escaping from the profiled recess 7a. The cable duct A and diverter B are thus connected to one another detachably, pivotably and, in the longitudinal direction, displaceably relative to one another.

The closing parts 7 are pushed apart by the splaying part 12. A splaying part 12 may have, directly beside its extension or projection intended for the splaying of the cable duct A, mating profiles with respect to the profiled recess 7a of the closing parts 7, in order to set the height H of the splaying 37 exactly.

The dividing walls 3 and the webs 33 bearing the latching lug 31 and the latching groove 32 advantageously run parallel to one another and perpendicular to a central region 34 of the profile parts A1, A2, which is optionally of plane design and situated between two curved regions. The plane central region 34 improves the bearing of the, in the use position, upper profile part A1 against pipes 19 having different diameters.

It is provided that the latching noses or latching lugs 31 and the latching grooves 32 are displaceable relative to one another in the longitudinal direction of the profile parts A1, A2, thereby resulting in the advantage that the cable duct A can be bent around corners or laid with bends, with simultaneous relative displacement of the profile parts A1, A2 connected to one another.

The extent of the elastic bracing of the profile parts A1, A2 or the pressing-together or separation of the closing parts 7 is achieved by appropriate spacing of the cooperating holding elements 1, 2 from the wall or shell 35 of the profile part A1, A2. If holding elements 1, 2 whose latching lugs 31 lie above a plane connecting the closing parts 7 of a profile part A1 or A2 are latched, the closing parts 7 are pressed against one another when the profile parts A1, A2 are connected.

The end regions advantageously have plane surfaces which are elastically pressed against one another and close off the cable duct. These lateral surfaces are free from connecting or latching elements or other interenaging or cooperating connecting elements and bear in a planar manner or with their outer edges against one another. The connection of the profile parts A1, A2 is effected not via the end regions or the surfaces pressed against one another, but via the holding elements 1, 2, which are situated in the interior of the cable duct at a distance from the end surfaces and form chambers for cables.

1-16. (canceled)

17. A cable duct for guiding a plurality of cables, including optical waveguides, the cable duct comprising:
profile parts including an upper profile part having lateral end regions and a lower profile part having lateral end regions and disposed mutually opposite of said upper profile part, said lateral end regions of said upper and lower profile parts function as closing parts closing off the cable duct, in a use position of the cable duct said lateral end regions one of bearing against one another and pressed against one another, said profile parts having holding elements for holding together said upper and lower profile parts, said holding elements having latching lugs and latching grooves latchable to one another, said holding elements being securable by joining together to each other, said holding elements disposed equidistant from a cross-sectional center of the cable duct and at a distance from said lateral end regions, and in that, on at least one of both sides of said cross-sectional center and in regions of said profile parts laterally adjoining said closing parts, chambers bounded by said holding elements extending in a longitudinal direction of said profile parts are delimited for guiding of lines or the cables, said lateral end regions having outer sides with profiled recesses formed therein for laterally introducing the cables into or leading them out of the cable duct; and
a diverter having an aperture formed therein for leading the cables through and connected to said profile parts, said diverter having a diverter body and guide parts one of formed on said diverter body and leading from said diverter body, said diverter being placed onto said closing parts of both of said profile parts by said guide parts, said guide parts having a mating profile adapted to said profiled recesses.

18. The cable duct according to claim 15, wherein said lateral end regions each have a wall with an outer wall surface, said upper profile part has a curvature over one of said wall and said outer wall surface of at least one of said lateral end regions.

19. The cable duct according to claim 15, wherein said upper profile part and said lower profile part have one of a same cross-sectional shape and an identical construction.

20. The cable duct according to claim 15, wherein said closing parts bear against one another in a joined-together position of said two profile parts.

21. The cable duct according to claim 15, wherein said profile parts have on both sides of said cross-sectional center, dividing walls extending in the longitudinal direction of said profile parts and keeping a central region free for a passage of fastening devices, including screws, said dividing walls being formed on positions on said profile parts which are mutually opposite in a joined-together state of said profile parts.

22. The cable duct according to claim 19, wherein said dividing walls bear extensions leading off from said dividing walls and define further chambers, said extensions coming to bear against one another when said profile parts are joined together and serving for holding the cables in said further chambers and for mutual support of said profile parts.

23. The cable duct according to claim 20, wherein:
said holding elements have webs; and
at least one of said holding elements, said dividing walls, said extensions, said webs, said latching lugs and said latching grooves extend continuously in the longitudinal direction of said profile parts.

24. The cable duct according to claim 15, wherein:
said lateral end regions each have a holding projection; and
said profiled recesses are formed symmetrically with respect to a central plane which runs longitudinally through said profile parts and are bounded by said holding projection situated on said lateral end regions of said profile parts.

25. The cable duct according to claim 22, wherein:
said diverter is mounted by said guide parts in said profiled recesses so as to be pivotable about an axis running in the longitudinal direction of the cable duct; and
said diverter is displaceable by said guide parts in a smooth-running manner on said profiled recesses in the longitudinal direction of the cable duct.

26. The cable duct according to claim 22, further comprising at least one splaying part insertable between said profile parts and leads off from said diverter body, said splaying part tapering in a wedge shape in a direction of said guide parts.

27. The cable duct according to claim 24, wherein:
said diverter body has a central region with an aperture formed therein, said aperture provided for leading a cable through; and
said diverter body having an end with a leadthrough formed therein remote from said profile parts and forming with said aperture a cable leadthrough.

28. The cable duct according to claim 25,
further comprising a further splaying part;
further comprising a further guide part; and
wherein said diverter body, said guide part, said splaying part, said aperture for leading cables through, said further splaying part and said further guide part are formed along the cable duct, symmetrically with respect to a central plane through said diverter body.

29. The cable duct according to claim 22, wherein a height of said diverter body at a wall surface facing said profile parts corresponds to a thickness of the cable duct splayed by spreading out said closing parts.

30. The cable duct according to claim 15, wherein said diverter is mounted by said guide parts in said profiled recesses so as to be pivotable about an axis running in the longitudinal direction of the cable duct.

31. The cable duct according to claim 15, wherein said lateral end regions each have a wall with an outer wall surface, said upper profile part has a curvature over one of said wall and said outer wall surface of two of said lateral end regions.

32. The cable duct according to claim 15, wherein said profiled parts are made from an elastic material.

33. The cable duct according to claim 15, wherein said profiled parts are made from a plastic.

34. The cable duct according to claim 15, wherein said closing parts bear against one another in a joined-together position of said two profile parts under elastic deformation of said profile parts.

35. The cable duct according to claim 22, wherein said diverter is displaceable by said guide parts in a smooth-running manner on said profiled recesses in the longitudinal direction of the cable duct.

36. A diverter for a cable duct containing profile parts having closing parts with profiled recesses formed therein, the diverter comprising:
a diverter body having an aperture formed therein for leading cables through and for connecting to the cable duct, said diverter body having guide parts one of formed on said diverter body and leading from said diverter body, said diverter body being placed onto the closing parts of both of the profile parts by said guide parts, said guide parts having a mating profile adapted to the profiled recesses.
